(19) United States
(12) Patent Application Publication
(10) Pub. No.: US 2024/0424327 A1
(43) Pub. Date: Dec. 26, 2024

(54) DEVICE FOR CONTRAINING A VEHICLE FIRE

(71) Applicant: Timo Jokinen, PALOKKA (FI)

(72) Inventor: Timo Jokinen, PALOKKA (FI)

(73) Assignee: FireAidBox Oy, PALOKKA (FI)

(21) Appl. No.: 18/692,079

(22) PCT Filed: Sep. 30, 2022
(86) PCT No.: PCT/FI2022/050652

§ 371 Date: Mar. 14, 2024

(30) Foreign Application Priority Data
Sep. 30, 2021 (FI) 20216013

(51) Int. Cl. A62C 3/07

(52) U.S. Cl. CPC A62C 3/07

(57) ABSTRACT

A device for constraining a vehicle fire is configured to surround a burning vehicle and is configured as a movable framework larger than a vehicle. The framework is confined with a fireproof material and one end of the framework includes a door. The door is a tambour door.

The invention relates to a device for constraining a vehicle fire, which device is configured to surround a burning vehicle and is configured as a movable framework larger than a vehicle, wherein the framework is confined with a fireproof material, and wherein one end of the framework includes a door.

NL1021213C1 discloses a device, specifically a blanket, which can be spread over a burning vehicle, and which is intended to suppress or at least constrain a vehicle fire. The edges of the disclosed blanket also include conduits which are fillable with, for example, water. The mass of the water thus presses the edges of the blanket against the underlying surface so that the blanket is held more securely in place.

The device just described typically forms part of the equipment of the emergency services. The device thus reaches the scene of a fire after a long delay. In addition, handling the blanket requires at least two people, preferably four to six people. Even in areas with a denser population, it takes at least half an hour for the emergency services to arrive at the scene of a fire, by which time the vehicle fire has frequently had the time to progress from a smouldering to the stage of a full-blown fire. During this time, for example, an indoor car park will have suffered significant smoke damage. At the very least, any other vehicles or other structures in the vicinity will also be damaged by the heat. Conducting water into the conduits requires a water point or mobile water tank.

The object of the invention is to provide a novel device which is simpler and easier to deploy than to date and by means of which the adverse effects of a vehicle fire can be mitigated. The characteristic features of a device according to the invention are indicated in the attached patent claims. The device according to the invention is simple and inexpensive so that it can be provided as part of an indoor car park or the like without significant costs. In addition, the device can be used by a single person, whereby a vehicle fire can be constrained very quickly upon detection. The device also facilitates the task of the emergency services of putting out the vehicle fire for good.

The invention is illustrated in the following in detail with reference to the attached drawings illustrating an embodiment of the invention, wherein

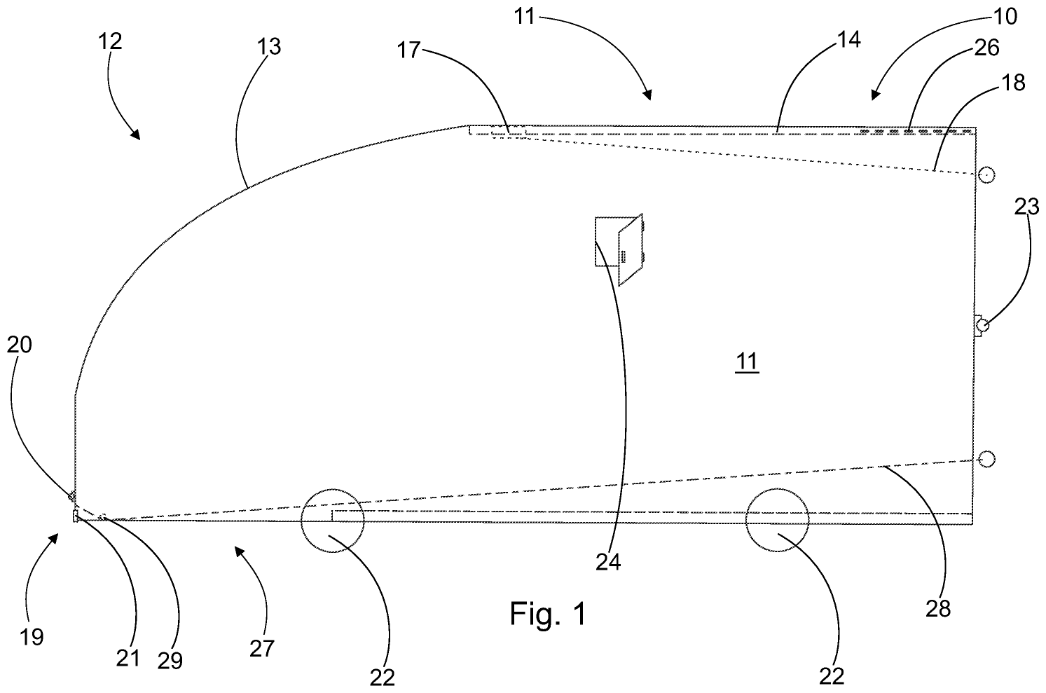

FIG. 1 shows a device according to the invention in a side view from the left,

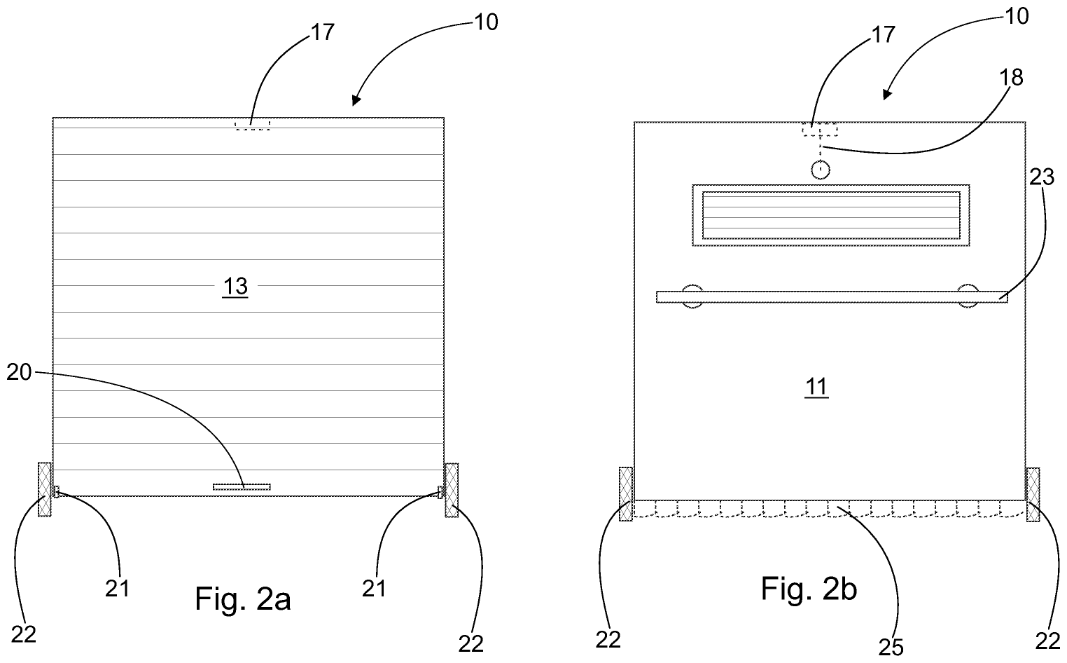

FIG. 2a shows the device of FIG. 1 in a front view,

FIG. 2b shows the device of FIG. 1 in a rear view,

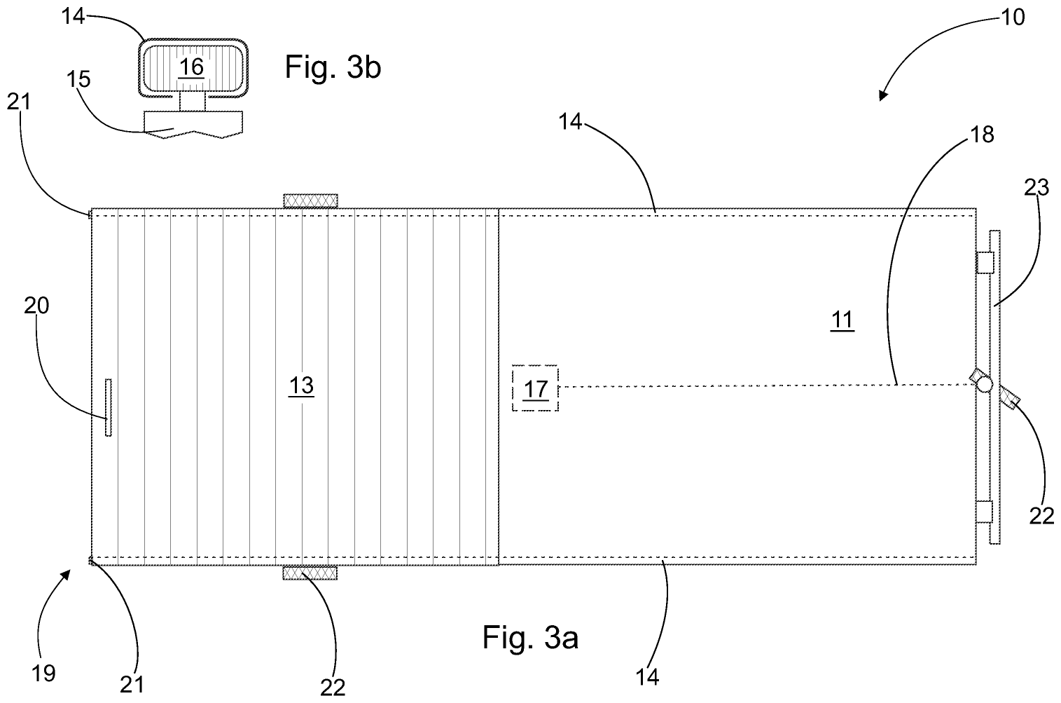

FIG. 3a shows the device of FIG. 1 in a top view,

FIG. 3b shows a partial enlargement of FIG. 3a,

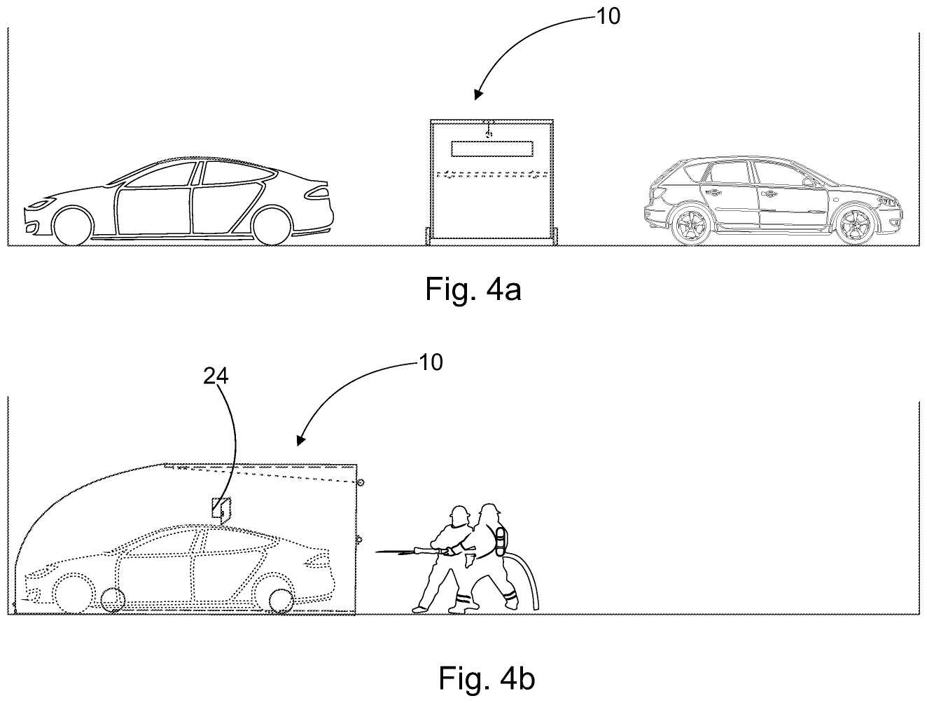

FIG. 4a shows an initial stage of a vehicle fire,

FIG. 4b shows a final stage of a vehicle fire.

FIGS. 1-3b show a device for constraining a vehicle fire according to the invention. The most common vehicle is the passenger car, for which most parking facilities are designed. The device is configured to surround a burning vehicle when in use, as shown in FIG. 4b. The device according to the invention is configured as a movable framework 10 larger than a vehicle, wherein the framework 10 is confined with a fireproof material 11. The framework allows the fireproof material to be held in a shape so that its placement around the vehicle is easy. The device is also provided with a sufficient rigidity by means of the framework so that handling of the device is easy. The framework is light enough to be handled yet heavy enough so as to retain its position despite a vehicle fire.

For example, the framework can be formed as a pipe frame covered with a fireproof material. The material is sheet metal and/or fabric. In other words, it is possible to use different materials in one and the same device. For example, a pipe frame can be covered with a fabric. On the other hand, it is possible with suitable bends and reinforcements to form a self-supporting framework from sheet metal so that a separate frame is superfluous. In this respect too, different structures can be combined in one and the same device. For example, a self-supporting framework can nevertheless include separate reinforcements.

An object of the invention is to achieve a lightweight framework that is easy to handle without auxiliary equipment. The framework forms a one side open box-like space with room for a vehicle. The open side of the framework in use is placed against the underlying surface so that the vehicle fire can be constrained and even extinguished. When in use, the framework is thus placed tightly against the underlying surface so that the vehicle fire can be prevented from spreading and, conversely, air can be prevented from entering the framework to fuel the fire.

In principle, the framework can be lifted or tipped over onto the vehicle. However, this already requires more than one person or at the very least some kind of auxiliary equipment. One end of the framework 10 accordingly includes a door 12. The device can thus be moved over the vehicle easily when the door is open. The door 12 is preferably a tambour door 13, which does not take up much space and which can be integrated as part of the framework. One specific embodiment of a tambour door is a slatted roller shutter. FIG. 3b shows an enlargement of part of a tambour door 13. In the edges of the framework here is a formed C-rail 14 inside which a roller carriage 15 moves. Rollers 16 are mounted in bearings at each end of the roller carriage 15. The tambour door 13 is thereby sturdy yet responsive to movement. In other words, the tambour door is easy to use. Rigid metal slats or, alternatively, a fireproof fabric is attached to the roller carriages. The tambour door is thus tight. The C-rail extends substantially along the entire length of the framework. The C-rail thus has a reinforcing function, and the tambour door opens wide.

The tambour door with its smooth motion is easy to close by hand. The tambour door 13 is also preferably spring-loaded so that closing the tambour door is quick and easy. For example, a spring 26 that forces the tambour door in the direction of a closed position can be arranged inside the C-rail 14. A tensioned spring gives an initial push to the tambour door, which finally closes under its own weight (FIG. 1). In the illustrated embodiment, the tambour door 13 includes retaining means 17 for holding the tambour door 13 open. The tambour door thereby remains open despite the action of the spring to close it. This is especially advantageous when the device is being moved. The tambour door is thus prevented from closing unintentionally. The tambour door's own mass will also tend to cause it to close.

As illustrated in FIG. 3a, the retaining means 17 are arranged in the top part of the tambour door 13 in the middle of the roof of the framework 10. To facilitate its operation, the retaining means 17 includes a remote release 18 which extends to the end of the framework 10 opposite the tambour door 13. The tambour door can thus be closed simply by releasing the retaining means using the remote release. In its simplest form, the remote release is a cord or wire cable that releases the retaining means when pulled. The end of the cord can include a toggle with which it is possible to get a good grip.

When released, the spring-loaded tambour door closes without manual contact. The tambour door 13 further includes automatic locking means 19 for holding the tambour door 13 shut. In other words, the locking means are activated in the final stage of closing so that the tambour door remains securely shut. If necessary, it is possible to release the locking means and open 10 the tambour door. The tambour door also includes a handle 20 just in case. The tambour door can thus be closed manually if the spring load is insufficient or, for example, if the spring loading malfunctions. In the illustrated embodiment, the locking means include two clips 21 arranged at the bottom edge of the framework. The clip is a simple mechanism which, after initially clearing the leading edge of the tambour door, catches the leading edge, thus preventing an unintentional opening of the tambour door.

Additionally or alternatively to the spring or handle, the tambour door 13 can include pulling means 27 for pulling the tambour door 13 shut. For example, it is possible to use a wire cable 28 that is attached to the leading edge of the tambour door 13 and conducted via a pulley 29 to the rear part of the device (FIG. 1). It is thereby possible to close the tambour door by pulling on the wire cable.

The tambour door may be provided in the end of the framework only, i.e. in the part consisting of the front wall. In the illustrated embodiment, in addition to the end of the framework 10, the tambour door 13 covers 5-50% of the length of the framework 10. In other words, part of the roof of the framework is formed by the tambour door. A curved design facilitates the motion of the tambour door while simultaneously allowing the volume of the device to be reduced. The less air there is inside the framework, the more likely it is that the vehicle fire will dwindle and even go out on its own.

The framework can be carried or dragged along a surface, although this requires more than one person to deploy the device. In addition, the framework is subject to wear while the surface can be marked by dragging. The framework 10 accordingly includes wheels 22 for moving the framework 10 by pulling and/or pushing. Four wheels are used in the illustrated embodiment, two on each side. Only two wheels arranged at points essentially along the longitudinal centre of gravity will also suffice. Preferably, however, two non-pivoting wheels are used at the front together with two or a single completely pivotable wheel at the back. FIG. 3a shows a single completely pivotable wheel 22 at the back. The device thus moves steadily while allowing an easy and agile control. At the same time, the entire weight of the framework rests on the wheels. This allows a user to concentrate on moving the framework horizontally without having to support the framework. Instead of a single wheel, it is possible to employ sets of wheels or other solutions in order to ensure the free movement of the framework.

Indoor car park floors can also include inclines in addition to uneven thresholds as well as speed bumps. The framework should thus possess a sufficient ground clearance. In other words, the wheels provide a sufficient clearance between the framework and the underlying surface. Small wheels suffice on hard surfaces indoors whereas larger wheels are used, for example, on gravel surfaces outdoors. Regardless of the size of the wheel, a gap remains at the lower edge of the framework. Accordingly, each wheel 22 preferably has a transport position relative to the framework 10 and an operational position in which the wheel 22 is higher than the lower edge of the framework 10. The framework can thereby be lowered against the underlying surface. The support of the wheel can be realized in various manners, but the elimination of the ground clearance is essential. The support of the wheel can be releasable, for example, by means of a pedal or by means of a remote release in the manner of the tambour door. FIG. 4b shows the wheels in the operational position so that the device is lying against the underlying surface.

In principle, the framework can be pushed from any direction. A grip 23 is provided, however, at the end opposite the tambour door 13. The grip is robust for pulling the framework as well as for steering the framework when pushed or pulled. Moreover, the grip guides a correct and safe use of the device. The grip here is a wide bar, although the use of smaller individual grips is also possible.

As illustrated in FIG. 2b, a part of the material of the end opposite the tambour door 13 is transparent. In other words, a functional window which one can look through is provided in the end in question. When the tambour door is open, a user can thus see where he or she is pushing the device (FIG. 4a). The window can be made of, for example, fireproof plexiglass. It is possible for the window to be formed by a hatch which is open when the device is being moved but which can be closed with an adequate tightness for the duration of a vehicle fire.

In principle, the device is to be rendered as tight as possible so that a vehicle fire is suppressed. This simultaneously prevents the spread of smoke and soot into the surrounding area. The material of the framework 10 can, however, include an opening 24 for introducing an extinguishing agent into the framework 10. A vehicle fire can thereby be actively extinguished.

For example, the aforementioned hatch can be utilized as the opening.

A tightness of the device can be improved, for example, by providing the framework 10 with flexible flaps 25. The flaps can be made of, for example, a lightweight fireproof fabric, but still provide a sufficient sealing.

The foregoing describes a device capable of constraining a fire, in particular a vehicle fire, which is light and easy to transport. For example, the device includes a roof and walls made of a thin material, wherein one of the walls is configured as a tambour door. The wheels allow the device to be moved by a single person. There could be, for example, one device at each level of an indoor car park. If a vehicle, for example a passenger car, catches fire, the device is pushed over the vehicle, e.g. passenger car, so as to surround the car. The spring-loaded tambour door is shut, and the wheels are, for example, collapsed so as to lower the device onto the underlying surface. The burning vehicle is thereby thoroughly covered, thus constraining the fire to the interior of the device, which allows more time for other cars to be moved or for the emergency services to arrive. The device also protects the surrounding area and prevents smoke and soot damage. The device is reusable.

The device is made of a non-combustible material such as aluminium or steel. Aluminium is by nature non-combustible and even a millimetre-thick steel plate withstands a fire for a sufficient amount of time. The device constrains the burning vehicle together with the fire in the unit, i.e. protects other vehicles as well as other structures in the surrounding area.

In FIG. 4a, the vehicle on the left has started to smoulder. If an initial extinguishing effort is unsuccessful, for example with a powder extinguisher, or if a suitable extinguisher is not available, the device, which can be stored at each level of the indoor car park, is brought to the scene. In FIG. 4a, the device is pushed to the scene along an aisle with the tambour door open. In other words, the device is transported onto the burning vehicle. The wheels, which roll easily and smoothly, allow the device to be transported by a single person. Once the device has been placed over the vehicle, the wheels are raised up by means of a pedal so that the device falls against the underlying surface. In addition, the spring-loaded tambour door is released so as to drop down, thus restricting the intake of oxygen into the device.

In FIG. 4b, the device is already lowered down over the vehicle with the tambour door closed. Nearby vehicles have also been moved away and the emergency services have begun to put out the fire. Water or extinguishing foam can be introduced, for example, via the opening 24.

By means of the device, the fire either dies out or at the very least is constrained for approximately half an hour, which gives the emergency services time to get to the scene. The material can withstand the stage of a full-blown fire, but it is preferable to try to extinguish a vehicle fire in order to minimize damage. The size of the device is easily modifiable, but a device of a size of, for example, 2000 mm*2000 mm*5000 mm covers the sizes of 90% of current passenger vehicles. Generally speaking, the device is preferably 2000-2500 mm in width, 1500-2500 mm in height and 5000-6000 mm in length. Depending on the size and design of the wheels, the stall can be used anywhere from an indoor car park to a level gravel surface. The device is light, its weight being around 120 kg when made of aluminium and around 300 kg when made of steel plate. Besides indoor car parks, the device can be used, for example, in outdoor car parks, parks, parking areas in front of shops and in industrial parks. When not in use, the device can be utilized as a storage space or some other form of shelter, as long as it is ensured that the device is always ready to be deployed and transported onto a vehicle that has caught fire in order to constrain and even suppress a vehicle fire.

1. A device for constraining a vehicle fire, which device is configured to surround a burning vehicle and is configured as a movable framework larger than a vehicle, wherein the framework is confined with a fireproof material, and wherein one end of the framework includes a door, wherein the door is a tambour door.

2. The device according to claim 1, wherein the material is sheet metal and/or fabric.

3. The device according to claim 1, wherein the tambour door is spring-loaded.

4. The device according to claim 1, wherein the tambour door includes retaining means for holding the tambour door open.

5. The device according to claim 4, wherein the retaining means includes a remote release which extends to the end of the framework opposite the tambour door.

6. The device according to claim 1, wherein the tambour door includes automatic locking means for holding the tambour door shut.

7. The device according to claim 1, wherein in addition to the end of the framework, the tambour door covers 5-50% of the length of the framework.

8. The device according to claim 1, wherein the framework includes wheels for moving the framework by pulling and/or pushing.

9. The device according to claim 8, wherein the wheel has a transport position relative to the framework and an operational position in which the wheel is higher than the lower edge of the framework.

10. The device according to claim 1, wherein the end opposite the tambour door is provided with a grip.

11. The device according to claim 1, wherein a part of the material of the end opposite the tambour door is transparent.

12. The device according to claim 1, wherein the material of the framework includes an opening for introducing an extinguishing agent into the framework.

13. The device according to claim 1, wherein the framework includes flexible flaps.

14. The device according to claim 1, wherein the device is 2000-2500 mm in width, 1500-2500 mm in height and 5000-6000 mm in length.

15. The device according to claim 1, herein the tambour door includes pulling means for pulling the tambour door shut.
